(19) United States
(12) Patent Application Publication
(10) Pub. No.: US 2025/0011170 A1
(43) Pub. Date: Jan. 9, 2025

(54) HIGH-PURITY NO2 GAS GENERATOR USING PLASMA, AND APPARATUS FOR MANUFACTURING HIGH-CONCENTRATION ACTIVATED WATER AND FERTILIZER WATER BASED ON NITRATE BY USING PLASMA

(71) Applicant: KOREA INSTITUTE OF FUSION ENERGY, Daejeon (KR)

(72) Inventors: Yong Cheol HONG, Goyang-si (KR); Geon Woo YANG, Gunsan-si (KR); Yong Wook SHIN, Gunsan-si (KR); Hae Kwang KIM, Gunsan-si (KR)

(73) Assignee: KOREA INSTITUTE OF FUSION ENERGY, Daejeon (KR)

(21) Appl. No.: 18/713,059

(22) PCT Filed: Nov. 23, 2022
(86) PCT No.: PCT/KR2022/018557

§ 371 Date: May 23, 2024

(30) Foreign Application Priority Data
Nov. 23, 2021 (KR) 10-2021-0162106

(51) Int. Cl. C01B 21/20; C01B 13/11; C05C 11/00; C05G 5/20; H05H 1/48

(52) U.S. Cl. CPC C01B 21/203; C01B 13/11; C05C 11/00; C05G 5/20; H05H 1/482; C01B 2201/70

(57) ABSTRACT

A high-purity NO₂ gas generation apparatus, according to the present invention, comprises: an ozone gas generator; a nitrogen oxide gas generator containing NO; and a mixing unit for mixing ozone from the ozone gas generator and gas from the nitrogen oxide gas generator. Gas containing NO₂ from the high-purity NO₂ gas generation apparatus may be supplied to an apparatus for producing high-concentration activated water and fertilizer water. The apparatus for manufacturing high-concentration activated water and fertilizer water, according to the present invention, comprises: an upright cylindrical column forming a flow path in the longitudinal direction; a water supply unit positioned above the column and supplying water to the flow path; a gas supply unit positioned below the flow path and supplying gas containing NO₂ gas; and a discharge port positioned at the lower end of the flow path and discharging a fluid.

### BACKGROUND

### Field of the Disclosure

The present disclosure relates to technology for generating NO₂ gas and producing high-concentration activated water and fertilizer water using the generated NO₂ gas.

### Description of Related Art

As nitric oxide (NO) has been proven to have beneficial medical effects on human health such as cardiovascular disease, anti-aging, skin care, and skin diseases, a nitric oxide aqueous solution that can be drunk or inhaled and a nitric oxide aqueous solution for sterilization and disinfection are being developed.

The nitrogen oxide aqueous solution is produced by binding oxygen and nitrogen to each other at ultra-high temperature via arc discharge using pure water and air as raw materials to produce nitric oxide gas and dissolving the nitric oxide gas into water.

In order to increase the effectiveness of this nitric oxide aqueous solution, it is necessary to increase the solubility of the nitric oxide in water.

Accordingly, the inventor of the present disclosure has developed a high-purity NO₂ gas generation apparatus and a high-concentration activated water producing apparatus that may mix nitrogen oxide and ozone with each other to increase the solubility of nitrogen oxide dissolved in water.

### PRIOR ART LITERATURE

### Patent Document

Korean Patent No. 10-1308788
Korean Patent No. 10-1379274

### SUMMARY OF THE INVENTION

A purpose of the present disclosure is to provide a high-purity NO₂ gas generation apparatus that generates high-purity NO₂ gas and a high-concentration activated water producing apparatus using the same which produces high-concentration activated water with an increased solubility of NO₂.

Moreover, a purpose of the present disclosure is to provide a high-concentration activated water producing apparatus that may monitor a concentration of NO₂ dissolved in water and, produce high-concentration activated water with a target solubility of NO₂ based on the monitoring result.

A high-purity NO₂ gas generation apparatus according to an embodiment of the present disclosure includes an ozone gas generator; a nitrogen oxide gas generator for generating nitrogen oxide gas including NO; and a mixer configured to mix ozone from the ozone gas generator and the nitrogen oxide gas from the nitrogen oxide gas generator with each other.

For example, the nitrogen oxide gas may include NO, N₂O₄, N₂O, NO₂, or N₂O₅.

In one embodiment, the ozone gas generator is a plasma apparatus, wherein the plasma apparatus is configured to convert gas containing oxygen into plasma to generate ozone.

In one embodiment, the plasma apparatus is a DBD or corona discharge plasma apparatus.

In one embodiment, the nitrogen oxide gas generator is a plasma apparatus, wherein the plasma apparatus is configured to convert gas containing oxygen and nitrogen into plasma to generate NO.

In one embodiment, the plasma apparatus is a gliding arc-type plasma apparatus.

In one embodiment, the gliding arc-type plasma apparatus includes: a bar-shaped inner electrode; a cylindrical outer electrode surrounding the inner electrode and spaced apart from the inner electrode; an injection portion for injecting gas containing oxygen and nitrogen into a space between the inner electrode and the outer electrode; and an outlet positioned opposite to the injection portion for discharging gas containing NO, wherein a spacing between the inner electrode and the outer electrode gradually increases as the inner electrode and the outer electrode extend toward the outlet in a longitudinal direction of the inner electrode, wherein a gliding arc is generated in the spacing.

In one embodiment, the high-purity NO₂ gas generation apparatus further includes a first cooling means for cooling the ozone gas from the ozone gas generator before being injected into the mixer.

The first cooling means may cool the ozone gas before it is mixed with the gas containing NO, thereby preventing the amount of ozone from being reduced.

In one embodiment, the high-purity NO₂ gas generation apparatus further includes a second cooling means for cooling the gas containing NO from the nitrogen oxide gas generator before being injected into the mixer.

The second cooling means cools the NO-containing gas before mixing it with the ozone gas, so that when the NO-containing gas and the ozone gas are mixed with each other, the temperature of the ozone gas may be prevented from increasing due to increase in the temperature of the NO-containing gas, and thus, the ozone amount may be maintained.

A high-concentration activated water and fertilizer water producing apparatus according to an embodiment of the present disclosure includes an upright cylindrical column having a flow path defined therein and extending along a longitudinal direction thereof; a water supplier located on a top of the column for supplying water to the flow path; a gas supplier located on a bottom of the flow path for supplying gas containing NO₂ gas to the flow path; and an outlet located on the bottom of the flow path for discharging fluid therethrough.

In one embodiment, the gas containing the NO₂ gas is generated from the NO₂ gas generation apparatus as defined above.

In one embodiment, a plurality of structured packings are received in the column and are stacked therein.

In one embodiment, the high-concentration activated water and fertilizer water producing apparatus further includes a circulation pipe branched from a discharge pipe connected to the outlet, wherein the circulation pipe is connected to the water supplier.

In one embodiment, the circulation pipe includes a valve or a circulation speed control pump.

In one embodiment, the circulation pipe includes pH detection means, wherein the high-concentration activated water and fertilizer water producing apparatus is configured to: compare pH detected by the pH detection means with a target pH; and to control the circulation speed control pump to adjust a circulation speed based on the comparing result, or to control the value to control whether circulation is blocked based on the comparing result.

In one embodiment, the high-concentration activated water and fertilizer water producing apparatus further includes an exhaust gas outlet located on a top of the column; and detection means for detecting a nitrogen oxide gas component and a concentration of nitrogen oxide gas in exhaust gas from the exhaust gas outlet, wherein the high-concentration activated water and fertilizer water producing apparatus is configured to: compare the nitrogen oxide gas component and the concentration thereof received from the detection means with a target component and a target concentration; and control the water supply, the NO₂ supply, or a circulation speed in the circulation pipe, based on the comparing result.

In one embodiment, the high-concentration activated water and fertilizer water producing apparatus further includes a water container on a top of the outlet and on a bottom of the column.

In one embodiment, NO₂ from the gas supplier is supplied to the water container through a bubbler.

In one embodiment, the water from the water supplier contains KOH or Ca(OH)₂.

According to the present disclosure, the high-purity NO₂ gas may be generated using the high-purity NO₂ gas generation apparatus, and the high-purity NO₂ gas may be supplied to the high-concentration activated water producing apparatus according to the present disclosure which in turn may produce high-concentration activated water with an increased solubility of NO₂. The high-concentration activated water producing apparatus may monitor the content of NO₂ dissolved in water, and based on the monitoring result, may produce the high-concentration activated water with a target solubility of NO₂.

### BRIEF DESCRIPTION OF THE DRAWINGS

FIG. 1 is a schematic diagram for illustrating a configuration of a high-purity NO₂ gas generation apparatus according to an embodiment of the present disclosure.

FIG. 2 is an enlarged view of a gliding arc-type plasma apparatus shown in FIG. 1.

FIG. 3 is a graph showing a concentration of nitrogen oxide produced in each of a conventional microwave plasma apparatus and the gliding arc-type plasma apparatus according to FIG. 2.

FIG. 4 is a graph showing a result of measuring a concentration of NO₂ generated using a high-purity NO₂ gas generation apparatus according to an embodiment of the present disclosure.

FIG. 5 is a perspective view for illustration a configuration of a high-concentration activated water producing apparatus according to an embodiment of the present disclosure.

FIG. 6 is a graph comparing a pH of a NO₂ aqueous solution (Present Example) produced using a high-concentration activated water producing apparatus according to an embodiment of the present disclosure with a pH of an NO₂ aqueous solution (Comparative Example) produced by dissolving the NO₂ gas generated using only a gliding arc-type plasma apparatus in water.

FIG. 7 is a graph measuring a concentration of nitrate ions produced by dissolving NO₂ in high-concentration activated water of each of Present Example and Comparative Example in FIG. 6.

### DETAILED DESCRIPTION OF THE INVENTION

Hereinafter, with reference to the attached drawings, a high-purity NO₂ gas generation apparatus and a high-concentration activated water producing apparatus to which the NO₂ gas therefrom is supplied, according to an embodiment of the present disclosure will be described in detail. The present disclosure may have various changes and may have various forms. Thus, specific embodiments are illustrated in the drawings and described in detail in the text. However, this is not intended to limit the present disclosure to the specific forms as disclosed. It should be appreciated that the present disclosure includes all modifications, equivalents, or substitutes included in the spirit and scope of the present disclosure. Like reference numerals have been used for like elements throughout the descriptions of the drawings. For simplicity and clarity of illustration, elements in the drawings are not necessarily drawn to scale.

It will be understood that, although the terms “first”, “second”, “third”, and so on may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section described under could be termed a second element, component, region, layer or section, without departing from the spirit and scope of the present disclosure.

The terminology used herein is directed to the purpose of describing particular embodiments only and is not intended to be limiting of the present disclosure. As used herein, the singular constitutes “a” and “an” are intended to include the plural constitutes as well, unless the context clearly indicates otherwise. It will be further understood that the terms “comprise”, “comprising”, “include”, and “including” when used in this specification, specify the presence of the stated features, integers, operations, elements, and/or components, but do not preclude the presence or addition of one or more other features, integers, operations, elements, components, and/or portions thereof.

Unless otherwise defined, all terms including technical and scientific terms used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

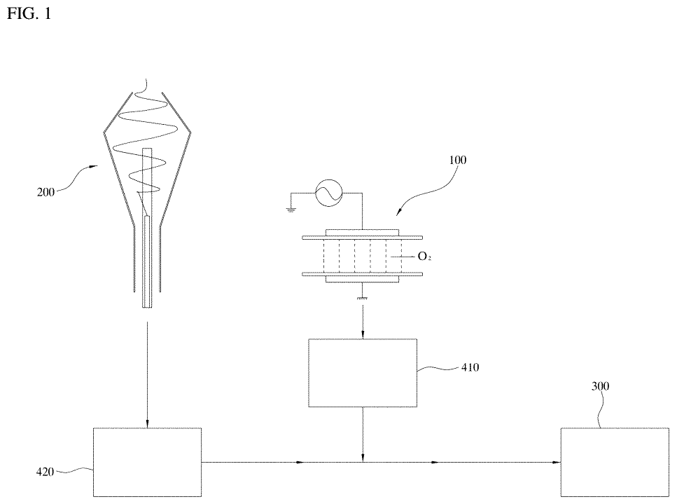

FIG. 1 is a schematic diagram for illustrating the configuration of a high-purity NO₂ gas generation apparatus according to an embodiment of the present disclosure.

Referring to FIG. 1, the high-purity NO₂ gas generation apparatus according to one embodiment of the present disclosure includes an ozone gas generator 100, a nitrogen oxide gas generator 200, and a mixer 300.

The ozone gas generator 100 is configured to generate ozone gas. In an example, the ozone gas generator 100 may be a plasma apparatus. The plasma apparatus may be configured to generate ozone by converting gas containing oxygen into plasma. The plasma apparatus may be a dielectric barrier discharge (DBD) or corona dischargeable plasma apparatus. For example, the plasma apparatus may be an apparatus that generates dielectric barrier discharge. There is no particular limitation on a structure of the plasma apparatus that generates the dielectric barrier discharge. Any structure including two electrodes with a dielectric therebetween may be used as the structure of the plasma apparatus that generates the dielectric barrier discharge.

The nitrogen oxide gas generator 200 may be configured to generate nitrogen oxide gas including NO. For example, the nitrogen oxide gas generator 200 may be a plasma apparatus, and the plasma apparatus may be configured to generate NO by converting gas containing oxygen and nitrogen into plasma. For example, the plasma apparatus constituting the nitrogen oxide gas generator 200 may be a gliding arc-type plasma apparatus.

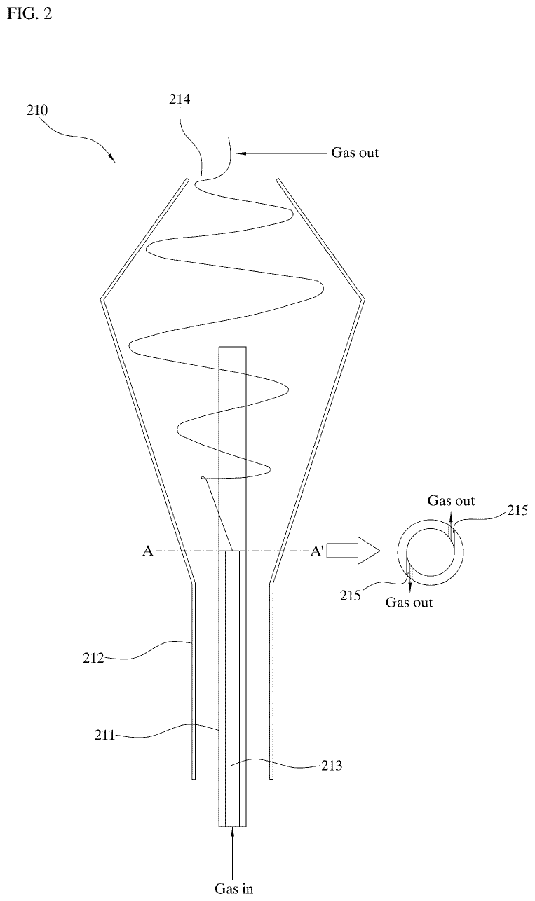

FIG. 2 is an enlarged view of the gliding arc-type plasma apparatus shown in FIG. 1.

Referring to FIG. 2, a gliding arc-type plasma apparatus 210 may include a bar-shaped inner electrode 211, a cylindrical outer electrode 212 spaced apart from the inner electrode 211 and surrounding the inner electrode 211, an injection portion 213 for injecting gas containing oxygen and nitrogen into a space between the inner electrode 211 and the outer electrode 212, and an outlet 214 for discharging gas containing NO opposite to the injection portion 213. A spacing between the inner electrode 211 and the outer electrode 212 may gradually increase as the outer electrode 212 extends toward the outlet 214 in a longitudinal direction of the inner electrode 211.

The injection portion 213 may be embodied as a hollow space defined in the inner electrode 211 and along the longitudinal direction of the inner electrode 211. A swirl gas outlet 215 may be defined in the inner electrode 211 at an end of the injection portion 213. In this regard, the swirl gas outlet 215 may extend in a tangential manner relative to the inner electrode 211, and there may be two swirl gas outlets 215.

The outlet 214 may be formed in an opposite side to the injection portion 213, that is, at an end of the outer electrode 212.

The inner electrode 211 may be partially hollow along the longitudinal direction thereof as acting as the gas injection portion 213. The outer electrode 212 may include an inclined surface surrounding the inner electrode 211. For example, the outer electrode 212 may have a structure in which a circumference dimension gradually increases and then decreases as the outer electrode extends in a longitudinal direction thereof. The plasma outlet of the outer electrode 212 may be open.

In this gliding arc-type plasma apparatus 210, power is supplied to the inner electrode 211 and the outer electrode 212 to generate gliding arc-type plasma. The gas containing oxygen and nitrogen is injected to the injection portion 213 defined in the inner electrode 211 The injected gas flows through the injection portion 213 and is discharged in a spiral manner through the swirl gas outlets 215. In this process, a gliding arc may be generated between the inner electrode 211 and the outer electrode 212. In this way, gliding arc-type plasma may be generated. In this regard, the gas containing oxygen and nitrogen is converted into plasma to generate NO, and the NO may be discharged through the outlet 214.

This gliding arc-type plasma apparatus may generate nitrogen oxide gas including NO more efficiently than other types of plasma apparatuses.

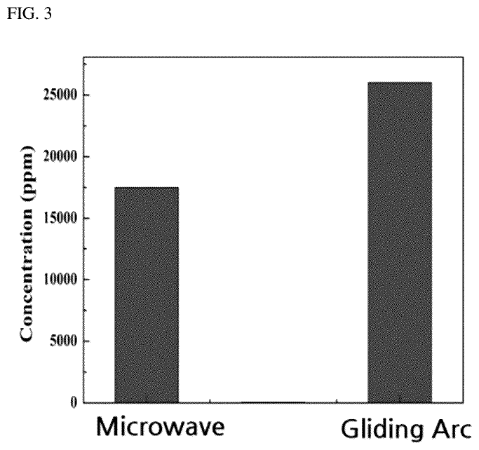

FIG. 3 is a graph showing a concentration of nitrogen oxide produced in each of a conventional microwave plasma apparatus and the gliding arc-type plasma apparatus according to FIG. 2.

Referring to FIG. 3, when 650 W is applied to the plasma apparatus, the concentration of nitrogen oxide in the conventional microwave plasma apparatus is about 16,000 ppm, while the concentration of nitrogen oxide produced in the gliding arc-type plasma apparatus according to FIG. 2 is about 26,000 ppm. Therefore, it may be identified that the concentration of nitrogen oxide generated in the gliding arc type plasma apparatus is higher relative to the input power thereto.

The mixer 300 may be configured to mix the ozone from the ozone gas generator 100 and the gas from the nitrogen oxide gas generator 200 with each other. There is no particular limitation on a structure of the mixer 300. For example, the mixer may be configured in a form of a chamber that provides a mixing space into which the ozone and the gas may be introduced and mixed with each other.

In one example, the high-purity NO₂ gas generation apparatus according to one embodiment of the present disclosure may further include a first cooling means 410 and a second cooling means 420.

The first cooling means 410 may cool the ozone gas from the ozone gas generator 100 before it is injected into the mixer 300. The first cooling means 410 may be connected to a rear end of the ozone gas generator 100 and configured to receive the ozone gas discharged from the ozone gas generator 100.

The second cooling means 420 may cool the gas containing NO from the nitrogen oxide gas generator 200 before it is injected into the mixer 300. The second cooling means 420 may be connected to a rear end of the nitrogen oxide gas generator 200 and configured to receive the gas containing NO discharged from the nitrogen oxide gas generator 200.

There is no particular limitation on a structure of each of the first cooling means 410 and the second cooling means 420. For example, each of the first cooling means 410 and the second cooling means 420 may be configured in a form of a heat exchanger in which the ozone or the NO gas is cooled via heat exchange between refrigerant fluid and the ozone or the NO gas.

The ozone in the ozone gas is decomposed quickly when a temperature thereof is high. Thus, the ozone may not be decomposed by cooling the ozone gas with the first cooling means 410. If the temperature of the gas containing NO is higher than the temperature of the cooled ozone, the temperature of the gas containing NO may increase the temperature of the ozone, such that the ozone may be easily decompose. Thus, it is preferable to cool the gas containing NO using the second cooling means 420. Therefore, after cooling the ozone and the NO gas using the first cooling means 410 and the second cooling means 420, respectively, the ozone and the NO gas are mixed with each other in the mixer 300. Thus, the amount of ozone may be prevented from being lowered and may be maintained such that the high-purity NO₂ gas may be generated.

In the high-purity NO₂ gas generation apparatus according to an embodiment of the present disclosure, the nitrogen oxide gas generator 200 converts gas containing oxygen and nitrogen into plasma to generate nitrogen oxide gas including NO. Thereafter, the generated gas containing NO is cooled using the first cooling means 410. Meanwhile, the ozone gas generator 100 generates ozone gas, and the generated ozone gas is cooled using the second cooling means 420. The cooled nitrogen oxide gas including NO and the cooled ozone gas are mixed with each other in the mixer 300 to generate NO₂ gas.

In order to measure a concentration of NO₂ gas in the gas finally generated in the mixer 300 in this process, while gradually increasing the voltage applied to the dielectric barrier plasma apparatus constituting the ozone gas generator 100 from 60 W to 90 W in a state in which the voltage applied to the gliding arc-type plasma apparatus 210 that constitutes the nitrogen oxide gas generator 200 is fixed to 70 W, the NO₂ concentration in the gas finally generated in the mixer 300 is measured based on the varying voltage level applied to the dielectric barrier plasma apparatus. A TESTO combustion gas analyzer was used as a measurement tool.

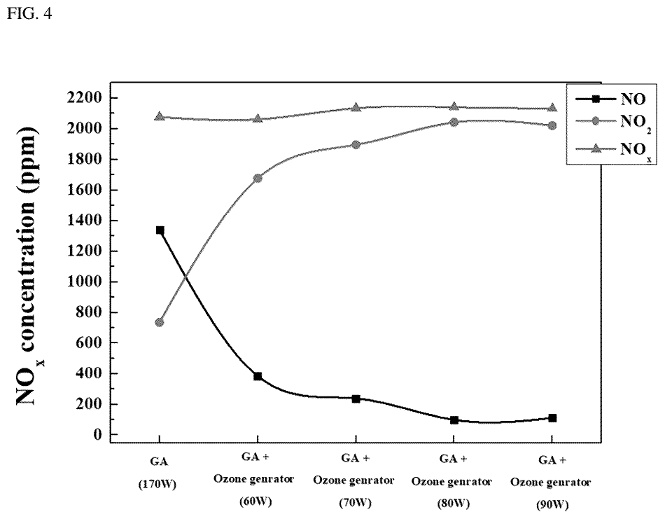

FIG. 4 is a graph showing the result of measuring the concentration of NO₂ generated using the high-purity NO₂ gas generation apparatus according to an embodiment of the present disclosure.

In FIG. 4, GA refers to a case where a gas containing NO is generated using only the gliding arc-type plasma apparatus 210, and the GA+Ozone generator refers to a case in which the gas containing NO is generated using all components of the high-purity NO₂ gas generation apparatus according to an embodiment of the present disclosure as described above.

As shown in FIG. 4, it may be identified that the NO₂ concentration is higher in the apparatus of the present disclosure than that obtained using only the gliding arc-type plasma apparatus 210. It may be identified that the NO₂ concentration increases when the voltage applied to the dielectric barrier plasma apparatus constituting the ozone gas generator 100 increases.

Therefore, the high-purity NO₂ gas may be generated using the high-purity NO₂ gas generation apparatus according to an embodiment of the present disclosure.

According to an embodiment of the present disclosure, the high-purity NO₂ gas generated using the high-purity NO₂ gas generation apparatus may be dissolved in water to produce high-concentration activated water with a high NO₂ solubility.

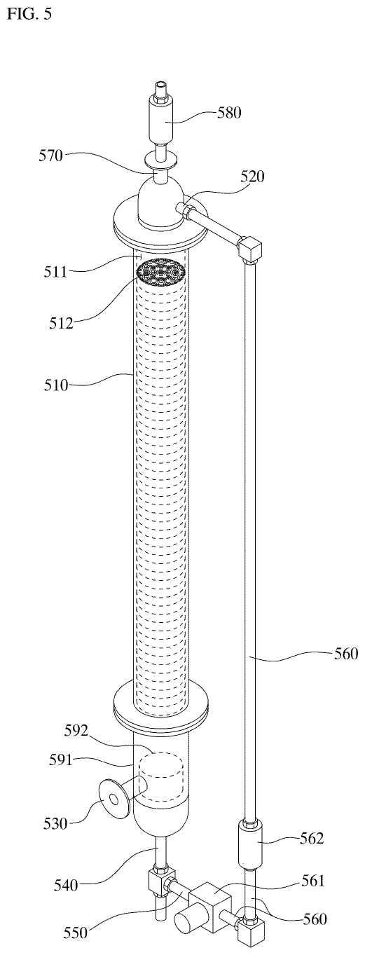

FIG. 5 is a perspective view for illustrating a configuration of a high-concentration activated water producing apparatus according to an embodiment of the present disclosure.

The high-concentration activated water producing apparatus according to an embodiment of the present disclosure is connected to a rear end of the mixer 300 of the high-purity NO₂ gas generation apparatus. The NO₂ gas may flow into the high-concentration activated water producing apparatus according to an embodiment of the present disclosure which may in turn dissolve the introduced NO₂ gas into water to produce the high-concentration activated water.

Referring to FIG. 5, the high-concentration activated water producing apparatus according to an embodiment of the present disclosure may include a column 510, a water supplier 520, a gas supplier 530, and an outlet 540.

The column 510 is provided as a vertically upright cylinder. A flow path 511 through which fluid can flow may be defined in and along a longitudinal direction of the column 510. The flow path 511 of the column 510 may be filled with a plurality of structured packings 512 stacked along a longitudinal direction of the flow path 511. The structured packing 512 refers to a packing of an open cell structure having a plurality of pores through which fluid can flow. In this regard, there are no particular restrictions on a shape and a material thereof. For example, the structured packing 512 may be made of a metal.

The water supplier 520 may be connected to a top of the flow path 511 in a fluid communication manner and may supply water to the top of the flow path 511. For example, the water supplier 520 in a form of a pipe may be connected to the top of the column 510.

The gas supplier 530 may be connected to a bottom of the flow path 511 in a fluid communication manner and may supply the gas containing NO₂ to the flow path 511. This gas supplier 530 may be connected to and disposed between the mixer 300 of the high-purity NO₂ gas generation apparatus and the column 510 according to an embodiment of the present disclosure, and may supply the NO₂ generated in the mixer 300 into the flow path 511.

The outlet 540 may be connected to the bottom of the flow path 511 in a fluid communication manner and may discharge fluid flowing through the flow path 511 therethrough. For example, the outlet 540 in a form of a pipe may be connected to the bottom of the flow path 511, and a discharge pipe 550 may be connected to an end of the outlet 540.

In one example, the high-concentration activated water producing apparatus according to one embodiment of the present disclosure may further include a circulation pipe 560. the circulation pipe 560 may include a valve (not shown) or a circulation speed control pump 561 and a pH detection means 562.

The circulation pipe 560 is branched from the discharge pipe 550 connected to the outlet 540 and is connected to the water supplier 520, so that the water in which the NO₂ discharged from the outlet 540 has been dissolved is circulated to the top of the flow path 511.

When the valve is installed in the circulation pipe 560, the valve may open and close a passage of the circulation pipe 560. For example, the valve may be an electronic on-off valve.

When the circulation speed control pump 561 is installed in the circulation pipe 560, the circulation speed control pump 561 increases or decreases the circulation speed of the water in which NO₂ has been dissolved circulating through the circulation pipe 560.

The pH detection means 562 may be installed on the circulation pipe 560, and may detect the pH of the water in which NO₂ has been dissolved circulating through the circulation pipe 560.

In one example, a controller (not shown) may be electrically connected to the pH detection means 562 and the circulation speed control pump 561 or the valve. The controller may be configured to receive a target pH value at which the solubility of NO₂ is set to a specific value and pre-store the target pH therein, and to compare the pH value of water in which NO₂ has been dissolved as detected by the pH detection means 562 with the target pH, and to control the circulation speed control pump 561 to control the circulation speed of water in which NO₂ has been dissolved based on the comparing result, to control the valve to control whether or not circulation is blocked.

For example, the target pH value may be set to a low pH value.

In this regard, the valve and the circulation speed control pump 561 may be used to control whether or not the NO₂-dissolved water circulates or the circulation speed thereof. In order to quickly reach the target pH value, it is advantageous to circulate the NO₂-dissolved water quickly. Thus, it is desirable to use the circulation speed control pump 561.

In one example, the high-concentration activated water producing apparatus according to one embodiment of the present disclosure may further include an exhaust gas outlet 570 located on the top of the column 510 and detection means 580 for detecting a component and a concentration of the nitrogen oxide gas in an exhaust gas from the exhaust gas outlet 570.

The gas is supplied through the gas supplier 530, and passes through the flow path 511 in which the gas comes into contact with water which is supplied through the water supplier 520, and then passes through the flow path 511. After the gas contacts the water, the gas is discharged through the exhaust gas outlet 570.

The detection means 580 may be electrically connected to the controller. A target composition and a target concentration of nitrogen oxide gas set to nitrogen oxide gas and a specific value, respectively. may be input and stored in the controller. Accordingly, the controller may be configured to compare the component and concentration of the nitrogen oxide gas from the detection means 580 with the target component and concentration, and to control the water supply, NO₂ supply, or the circulation speed of the NO₂-dissolved water that circulates through the circulation pipe 560, based on the comparing result.

For example, the target component may be set to nitrogen oxide gas. The target concentration may be set to a low value of the concentration of NO₂.

In one example, the high-concentration activated water producing apparatus according to one embodiment of the present disclosure may further include a water container 591 and a bubbler 592.

The water container 591 may be disposed between the bottom of the column 510 and a top of the outlet 540, and may be configured to accommodate therein a certain volume of water falling down to the bottom of the flow path 511.

The bubbler 592 may be accommodated inside the water container 591 and may be connected to the gas supplier 530, so that the NO₂ gas supplied through the gas supplier 530 flows into the flow path 511 in a form of bubbles.

Hereinafter, a process for producing the high-concentration activated water in which NO₂ has been dissolved using the high-concentration activated water producing apparatus according to an embodiment of the present disclosure is described.

First, the gas containing NO₂ generated from the high-purity NO₂ gas generation apparatus according to an embodiment of the present disclosure is supplied to the bottom of the flow path 511 of the column 510 through the gas supplier 530, while the water is supplied to the top of the flow path 511 of the column 510 through the water supplier 520.

In this regard, the water container 591 may be filled with water at a certain level, and the gas containing NO₂ is injected toward the bubbler 592 accommodated in the water container 591, and thus is supplied in a form of bubbles through the bubbler 592 within the water container 591. Accordingly, a portion of NO₂ may be dissolved in water at a timing when the supply thereof to the flow path 511 begins.

The water supplied to the flow path 511 falls down toward the bottom of the flow path 511, that is, toward the water container 591. The gas containing NO₂ undissolved in the water in the water container 591 flows toward the top of the flow path 511. In this regard, since the plurality of structured packings 512 are stacked inside the flow path 511, the gas containing and NO₂ the water pass through the plurality of structured packings 512. Thus, the movement thereof is delayed compared to a case in which the plurality of structured packings 512 are absent, such that sufficient contact therebetween may be made. Accordingly, NO₂ is dissolved in water, the water in which NO₂ has been dissolved falls down to the bottom of the flow path 511, and a portion of the gas not dissolved in water may be discharged through the exhaust gas outlet 570.

Meanwhile, the water in which NO₂ has been dissolved falling down to the bottom of the flow path 511 may be discharged through the outlet 540, or may be circulated to the top of the flow path 511 through the circulation pipe 560.

When being circulated through the circulation pipe 560, the water in which the NO₂ has been dissolved may be pumped by the circulation speed control pump 561 and may be supplied toward the top of the flow path 511. At this time, while the water circulates along the circulation pipe 560, the pH of the water in which the NO₂ has been dissolved is measured using the pH detection means 562. The pH value measured by the pH detection means 562 may be compared with the target pH value by the controller. Based on the comparing result, the controller may control the circulation speed control pump 561 to control the circulation speed of the water in which the NO₂ has been dissolved.

For example, when the pH value measured by the pH detection means 562 does not reach the target pH value, the controller controls the circulation speed control pump 561 to increase the circulation speed of the water in which the NO₂ has been dissolved, such that the number of times the water in which the NO₂ has been dissolved comes into contact with the gas containing NO₂ supplied through the gas supplier 530 may be quickly increased. Thus, the pH value measured by the pH detection means 562 may quickly reach the target pH value. Conversely, when the pH value measured by the pH detection means 562 reaches the target pH value, the controller may control the circulation speed control pump 561 to slow down the circulation speed of the water in which NO₂ has been dissolved.

The gas having contacted the water within the flow path 511 is discharged out of the flow path 511 through the exhaust gas outlet 570. In this regard, the exhaust gas discharged through the exhaust gas outlet 570 flows through the detection means 580 for detecting the component and the concentration of the nitrogen oxide gas from the exhaust gas. Thus, the component and the concentration of the nitrogen oxide gas are measured using the detection means 580.

The controller may compare the composition and the concentration of the nitrogen oxide gas from the measured exhaust gas with the target composition and the target concentration of the nitrogen oxide gas pre-stored in the controller. Based on the comparing result, the controller may control the water supply, NO₂ supply, or the circulation speed of the NO₂-dissolved water that circulates through the circulation pipe 560.

For example, when the composition and the concentration of nitrogen oxide gas from the exhaust gas measured by the detection means 580 fail to match the target composition and the target concentration, the controller may increase the amount of supplied water so that a larger amount of the NO₂ gas is dissolved in water.

Moreover, the pH detection means 562 and the nitrogen oxide component and concentration detection means 580 operate in a parallel manner. Thus, the controller may control the fluid circulation speed based on the detection data from both pH detection means 562 and the nitrogen oxide component and concentration detection means 580.

Using the high-concentration activated water producing apparatus according to an embodiment of the present disclosure, the gas containing NO₂ may be supplied in a form of bubbles, so that NO₂ is first dissolved in the water at the time of supplying the gas containing NO₂. Then, the water in which NO₂ has been dissolved is circulated. The pH of the water in which NO₂ has been dissolved in the process of circulating the water in which NO₂ has been dissolved is measured. The component and the concentration of the exhaust gas discharged after NO₂ has been dissolved in the water are measured. The solubility of NO₂ may be increased based on the measurement results. In this way, the high-concentration activated water with increased dissolved amount of NO₂ may be produced.

Moreover, the gas containing NO₂ supplied to the high-concentration activated water producing apparatus of the present disclosure is the high-purity NO₂ gas supplied from the high-purity NO₂ gas generation apparatus of the present disclosure. Thus, NO₂ may be dissolved in the water more easily and quickly, and the solubility of NO₂ in the high-concentration activated water may be further increased.

Moreover, a concentration of NO₂ dissolved in water may be monitored through the pH detection means 562 and the nitrogen oxide component and concentration detection means 580. Based on the monitoring result, the high-concentration activated water having the target NO₂ solubility may be produced.

The produced high-concentration activated water may be used for sterilization and disinfection in the food industry, and the medical field, and for water purification or production of the fertilizer in the agricultural and environmental fields.

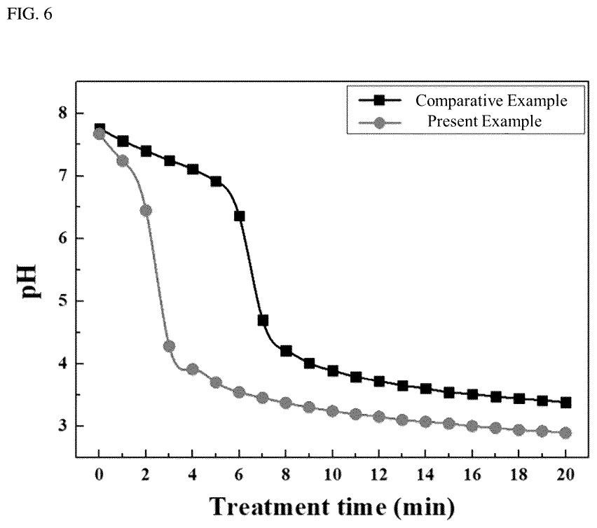

FIG. 6 is a graph comparing a pH of a NO₂ aqueous solution (Present Example) produced using a high-concentration activated water producing apparatus according to an embodiment of the present disclosure with a pH of an NO₂ aqueous solution (Comparative Example) produced by dissolving the NO₂ gas generated using only a gliding arc-type plasma apparatus in water.

As shown in FIG. 6, it may be identified that the pH of the high-concentration activated water of Present Example according to the present disclosure is lower compared to the pH of the high-concentration activated water of the Comparative Example. Thus, it may be identified that the solubility of NO₂ has increased when using the high-concentration activated water producing apparatus of the present disclosure.

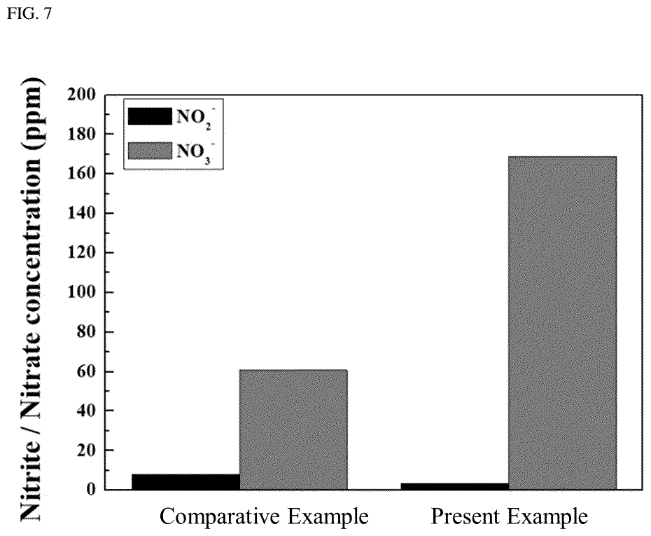

FIG. 7 is a graph measuring a concentration of nitrate ions produced by dissolving NO₂ in high-concentration activated water of each of Present Example and Comparative Example in FIG. 6.

As shown in FIG. 7, it may be identified that a concentration of nitrate ions (NO³) is high in Present Example according to the present disclosure. Thus, it may be identified that the solubility of NO₂ has increased when using the high-concentration activated water producing apparatus of the present disclosure.

In one example, the water supplied from the water supplier 510 of the high-concentration activated water production apparatus according to one embodiment of the present disclosure may contain KOH or Ca(OH)₂.

In other words, when K⁺ or Ca²⁺ along with water is supplied to the water supplier 510, the fertilizer water containing KOH or Ca(OH)₂ may be produced according to a following Reaction Formulas, and the fertilizer water may be used as a liquid fertilizer.

K⁺+OH⁻+H⁺+NO₃⁻→KNO₃+H₂O <Reaction Formula 1>

Ca²⁺+OH⁻+NO₃⁻→Ca(NO₃)₂+H₂O <Reaction Formula 2>

In one example, although not shown, the high-concentration activated water producing apparatus of the present disclosure may further include an outlet opening and closing valve disposed on the exhaust gas outlet 570 for opening and closing the outlet 540, an exhaust gas collection pipe branched from the outlet 540 and connected to the gas supplier 530, and a collection pipe opening and closing valve installed on the exhaust gas collection pipe to open and close the exhaust gas collection pipe.

In this case, when the composition and concentration of nitrogen oxide gas from the exhaust gas as detected through the nitrogen oxide composition and concentration detection means 580 fail to match the target composition and the target concentration, the exhaust gas of which the component and concentration have been measured may be collected to the gas supplier 530 through the exhaust gas collection pipe and supplied back to the flow path 511 of the column 510. Accordingly, when water and undissolved NO₂ gas therein remain in the exhaust gas, the undissolved NO₂ gas may be dissolved again in water, such that NO₂ in the gas supplied to the flow path 511 may be entirely dissolved in the water without being discarded.

Descriptions of the presented embodiments are provided so that anyone skilled in the art of the present disclosure may use or practice the present disclosure. Various modifications to these embodiments will be apparent to those skilled in the art of the present disclosure, and the general principles defined herein may be applied to other embodiments without departing from the scope of the present disclosure. Accordingly, the present disclosure is not limited to the embodiments presented herein, but should be construed in the broadest scope consistent with the principles and novel features presented herein.

What is claimed is:

1. A high-purity NO₂ gas generation apparatus comprising:
an ozone gas generator;
a nitrogen oxide gas generator for generating nitrogen oxide gas including NO; and
a mixer configured to mix ozone from the ozone gas generator and the nitrogen oxide gas from the nitrogen oxide gas generator with each other.

2. The high-purity NO₂ gas generation apparatus of claim 1, wherein the ozone gas generator is a plasma apparatus,
wherein the plasma apparatus is configured to convert gas containing oxygen into plasma to generate ozone.

3. The high-purity NO₂ gas generation apparatus of claim 2, wherein the plasma apparatus is a DBD or corona discharge plasma apparatus.

4. The high-purity NO₂ gas generation apparatus of claim 1, wherein the nitrogen oxide gas generator is a plasma apparatus,
wherein the plasma apparatus is configured to convert gas containing oxygen and nitrogen into plasma to generate NO.

5. The high-purity NO₂ gas generation apparatus of claim 4, wherein the plasma apparatus is a gliding arc-type plasma apparatus.

6. The high-purity NO₂ gas generation apparatus of claim 5, wherein the gliding arc-type plasma apparatus includes:
a bar-shaped inner electrode;
a cylindrical outer electrode surrounding the inner electrode and spaced apart from the inner electrode;
an injection portion for injecting gas containing oxygen and nitrogen into a space between the inner electrode and the outer electrode; and
an outlet positioned opposite to the injection portion for discharging gas containing NO,
wherein a spacing between the inner electrode and the outer electrode gradually increases as the inner electrode and the outer electrode extend toward the outlet in a longitudinal direction of the inner electrode,
wherein a gliding arc is generated in the spacing.

7. The high-purity NO₂ gas generation apparatus of claim 1, further comprising a first cooling means for cooling the ozone gas from the ozone gas generator before being injected into the mixer.

8. The high-purity NO₂ gas generation apparatus of claim 1, further comprising a second cooling means for cooling the gas containing NO from the nitrogen oxide gas generator before being injected into the mixer.

9. A high-concentration activated water and fertilizer water producing apparatus comprising:
an upright cylindrical column having a flow path defined therein and extending along a longitudinal direction thereof;
a water supplier located on a top of the column for supplying water to the flow path;
a gas supplier located on a bottom of the flow path for supplying gas containing NO₂ gas to the flow path; and
an outlet located on the bottom of the flow path for discharging fluid therethrough.

10. The high-concentration activated water and fertilizer water producing apparatus of claim 9, wherein the gas containing the NO₂ gas is generated from the NO₂ gas generation apparatus of claim 1.

11. The high-concentration activated water and fertilizer water producing apparatus of claim 9, wherein a plurality of structured packings are received in the column and are stacked therein.

12. The high-concentration activated water and fertilizer water producing apparatus of claim 11, further comprising a circulation pipe branched from a discharge pipe connected to the outlet, wherein the circulation pipe is connected to the water supplier.

13. The high-concentration activated water and fertilizer water producing apparatus of claim 12, wherein the circulation pipe includes a valve or a circulation speed control pump.

14. The high-concentration activated water and fertilizer water producing apparatus of claim 13, wherein the circulation pipe includes pH detection means,
wherein the high-concentration activated water and fertilizer water producing apparatus is configured to:
compare pH detected by the pH detection means with a target pH; and
to control the circulation speed control pump to adjust a circulation speed based on the comparing result, or to control the value to control whether circulation is blocked based on the comparing result.

15. The high-concentration activated water and fertilizer water producing apparatus of claim 13, further comprising:
an exhaust gas outlet located on a top of the column; and
detection means for detecting a nitrogen oxide gas component and a concentration of nitrogen oxide gas in exhaust gas from the exhaust gas outlet,
wherein the high-concentration activated water and fertilizer water producing apparatus is configured to:
compare the nitrogen oxide gas component and the concentration thereof received from the detection means with a target component and a target concentration; and
control the water supply, the NO₂ supply, or a circulation speed in the circulation pipe, based on the comparing result.

16. The high-concentration activated water and fertilizer water producing apparatus of claim 9, further comprising a water container on a top of the outlet and on a bottom of the column.

17. The high-concentration activated water and fertilizer water producing apparatus of claim 16, wherein NO₂ from the gas supplier is supplied to the water container through a bubbler.

18. The high-concentration activated water and fertilizer water producing apparatus of claim 9, wherein the water from the water supplier contains KOH or Ca(OH)₂.
